(19) United States
(12) Patent Application Publication
(10) Pub. No.: US 2011/0321105 A1
(43) Pub. Date: Dec. 29, 2011

(54) System and Method for Alternate Multi-Channel Bi-Directional Data Transmission

(76) Inventors: Vanessa Ogle, Richardson, TX (US); Bill Fang, Plano, TX (US); Tom Miller, Plano, TX (US); Jeff Johns, Murphy, TX (US)

(21) Appl. No.: 13/168,915

(22) Filed: Jun. 24, 2011

Related U.S. Application Data
(60) Provisional application No. 61/358,020, filed on Jun. 24, 2010.

(51) Int. Cl. H04N 7/173

(52) U.S. Cl. 725/98; 725/118

(57) ABSTRACT

A system and method are disclosed for alternate multi-channel bi-directional data transmission in a multi-unit environment. In one embodiment, legacy infrastructure connects entertainment centers in respective rooms to a service server to provide downstream communication from the service server to the entertainment center. To provide bi-directional data transmission, an upstream data transmission channel is provided which includes multiple transmission mediums from the entertainment centers to the service center. The resulting bi-directional channel is asymmetrical with respect to bandwidth and the upstream communication link includes non-continuous bandwidth links.

This application claims priority from co-pending U.S. Patent Application No. 61/358,020, entitled “System and Method for Alternate Multi-Channel Bi-Directional Data Transmission” and filed on Jun. 24, 2010, in the names of Ogle et al.; which is hereby incorporated by reference for all purposes.

### TECHNICAL FIELD OF THE INVENTION

This invention relates, in general, to communication systems in multi-unit environments and, in particular, to systems and methods for alternate multi-channel bi-directional data transmission for supporting interactive television and amenity control in a multi-unit environment, for example.

### BACKGROUND OF THE INVENTION

Without limiting the scope of the present invention, its background will be described with reference to television and amenity control in commercial applications, such as hotels. Many hotel rooms are equipped with coax only infrastructure that inhibits bi-directional communications from the in-room set top box to the hotel headend/back office. While several technologies exist for providing bi-directional data communications in a coax only environment, additional technology developments are needed as the existing technologies are expensive and cumbersome to implement as often costly conversions are required.

### SUMMARY OF THE INVENTION

It would be advantageous to achieve bi-directional data communications for use in a legacy or coax only environment that would complement existing legacy infrastructure, while creating an interactive entertainment experience. It would also be desirable to enable an electro-mechanical solution that would mitigate or eliminate the cost of providing bi-directional communication in multi-unit environments, such as hotels, hospitals, multi-family residences, and dormitories, for example. To better address one or more of these concerns, systems and methods are disclosed for alternate multi-channel bi-directional data transmission in a multi-unit environment. In one embodiment, legacy infrastructure, such as coax cable, connects an entertainment center in a multi-unit environment to a service server in the multi-unit environment to provide downstream communication from the service server to the entertainment center. Bridges are associated therewith and are interposed between the entertainment center and the service server.

The bridges may be wireless devices or a device having a purpose unrelated to the entertainment center, such as a thermostat or a combination thereof. To provide bi-directional data transmission, an upstream data transmission channel is provided which includes transmission mediums from the entertainment centers to the service center. The resulting bi-directional channel is asymmetrical with respect to bandwidth and the upstream communication link includes non-continuous bandwidth links. These and other aspects of the invention will be apparent from and elucidated with reference to the embodiment(s) described hereinafter.

By way of example, the bi-directional data transmission presented herein may be utilized with energy management, system health and status, enabling value added services (dynamic channel ordering, video-on-demand, interactive content, and interactive services (room service, valet, folio review), and collection of metrics (channels watched, TV utilized). Additionally, theft prevention and security, software and content updates, notification services (room service, security alert), in-room controls and automation (lighting, door locks, motion detection, curtain controls), and in-room amenity controls and reporting (window & sliding doors, electronic doors, mini-bar, in-room safe), for example.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is schematic diagram depicting one embodiment of a system for alternate multi-channel bi-directional data transmission according to the teachings presented herein;

FIG. 2A is a schematic diagram depicting one embodiment of a system in accordance in FIG. 1;

FIG. 2B is a schematic diagram depicting one embodiment of a wireless mesh for use in accordance with FIG. 2A;

FIG. 2C is a schematic diagram depicting one embodiment of a set top box for use with FIG. 2A;

FIG. 2D is a schematic diagram depicting one embodiment of a mesh unit for use with FIG. 2A;

FIG. 3 is a schematic diagram depicting another embodiment of a system in accordance in FIG. 1;

FIG. 4 is a schematic diagram depicting a further embodiment of a system in accordance in FIG. 1;

FIG. 5 is a schematic diagram depicting a still further embodiment of a system in accordance in FIG. 1; and

FIG. 6 is a schematic diagram depicting a method for alternate multi-channel bi-directional data transmission.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

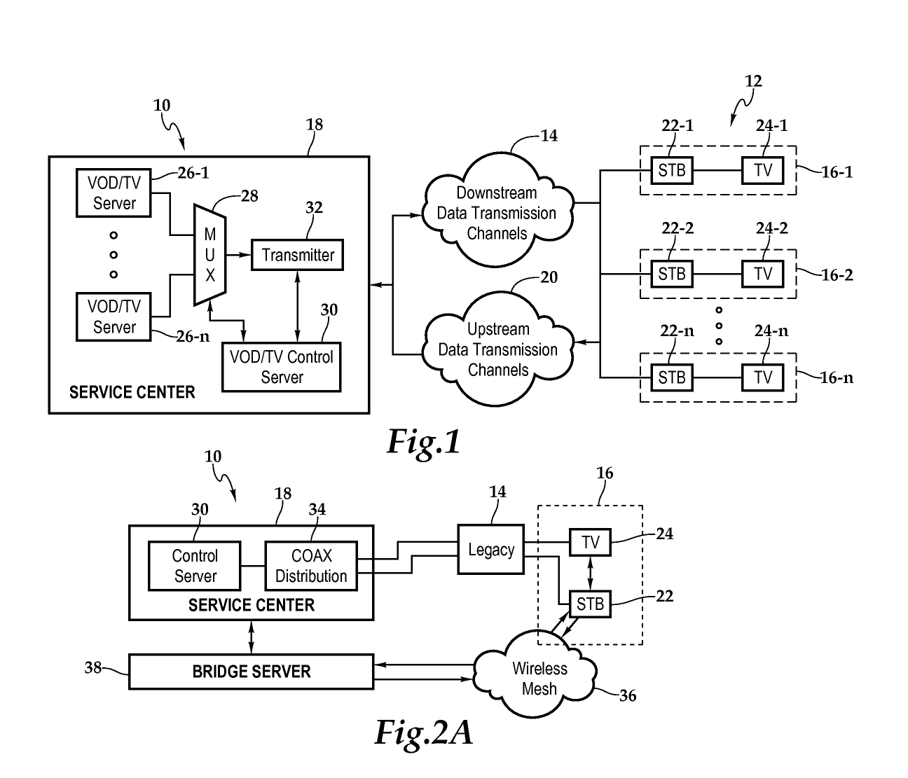

Referring initially to FIG. 1, therein is depicted a system 10 for alternate multi-channel bi-directional data transmission in a multi-unit environment 12, such as a furnished multi-family residence, dormitory, hotel, or hospital, for example. By way of further example, in addition to transient environments such as inns, public houses, and the like, the systems and methods may be utilized in a variety of residential environments. Likewise, the systems and methods may be utilized in non-residential and commercial settings such as airports, office buildings, and malls, for example.

Legacy infrastructure 14, such as coax cabling, connects multiple entertainment centers 16-1 through 16-n in respective rooms to a service server 18 in the multi-unit environment 12. The legacy infrastructure 14 is configured to provide downstream communication from the service server 18 to the multiple entertainment centers 16-1 through 16-n at a first bandwidth.

A post-construction infrastructure 20 is interposed between the entertainment centers 16-1 through 16-n and the service server 18. As will be discussed in further detail below, the post-construction infrastructure 20 is embedded in the multi-unit environment 12 following construction of the multi-unit environment 12. The post-construction infrastructure may have a second bandwidth. Each of the entertainment centers 16-1 through 16-n includes a bridge communicatively coupled to the post-construction infrastructure 20. Each of the bridges is configured to receive upstream data on a second transmission medium away from the entertainment centers 16-1 through 16-n and toward the service center 18. The second transmission medium may have a third bandwidth.

A second bridge, which will be discussed further hereinbelow, is communicatively coupled to the post-construction infrastructure 20 to forward upstream data on a third transmission medium; also away from the entertainment centers 16-1 through 16-n and toward the service center 18. The third transmission medium also has a fourth bandwidth. By way of this arrangement, an upstream data transmission channel 20 is configured to send upstream data from the entertainment centers 16-1 through 16-n to the service center 18. This upstream data transmission channel may include the first, second, and third transmission mediums. As mentioned, each of the first, second, third, and fourth bandwidths may be different.

With respect to the service center 18, in one embodiment, the service center 18 includes a video-on-demand (VOD) system having one or more VOD/TV headend servers 26-1 through 26-n capable of subscribing to various programming. The VOD/TV headend servers 26-1 through 26-n generate and/or transmit VOD/TV sessions through multiplexer 28, which is under the control of the VOD/TV control server 30. The programming is then transmitted to various subscribers or users in the multi-unit environment 12.

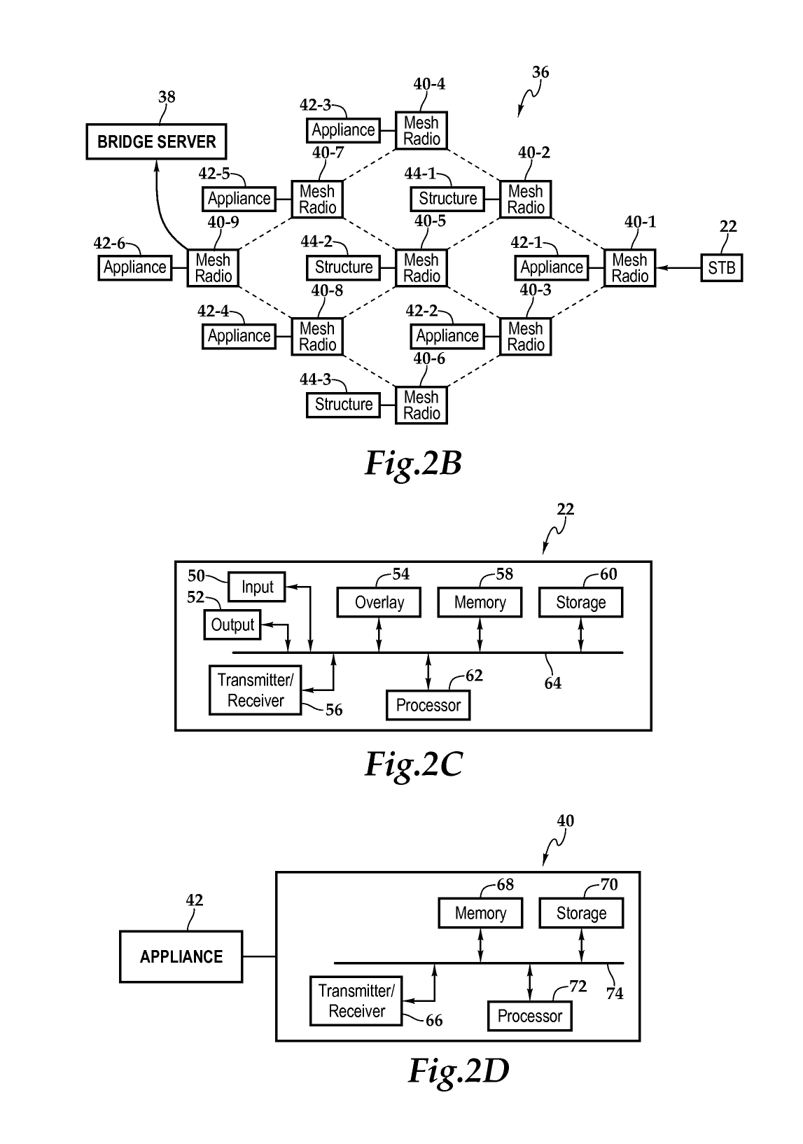

Referring to FIG. 2A, one embodiment of a system in accordance in FIG. 1 is depicted. Legacy infrastructure 14 connects a service center 18 having a control server 30 and coax distribution 34 to an entertainment center 16 including the television 24 and the set top box 22 in a room 16. Post-construction infrastructure 30 in the form of a wireless mesh network 36 is interposed between the entertainment center 16 and the service server 18. The mesh network 36 being installed post building completion, e.g., post hotel or hospital completion. The post-construction infrastructure or mesh network 36 is wireless and has a second bandwidth.

In this embodiment, the set top box 22 acts as a first bridge operating wirelessly to communicatively couple the entertainment center 16 to the wireless mesh network 36. In this way, the set top box 22 is configured to receive upstream data related to interactive entertainment from the television 24 and forward this data away from the entertainment center 16 and toward the service center 18. After the upstream data is forwarded through the mesh network 36, as will be described in FIG. 2B, a bridge server 38 receives the upstream data and forwards the upstream data to the service center 18. In this implementation, the bridge server 38, which is acting as a second bridge, uses a third transmission medium, such as, but not limited to, ethernet other cabling, having a fourth bandwidth. As alluded, the first, second, third, and fourth bandwidths may be different. In this manner, an upstream data transmission channel, which includes first, second, and third transmission mediums, is configured to send upstream data from the entertainment centers 16, including entertainment center, to the service center 18. As shown, the legacy infrastructure 14 and upstream data transmission channel combine to define an interactive entertainment center experience, via downstream and upstream communication.

Referring to FIG. 2B, one embodiment of the wireless mesh 36 is depicted wherein the set top box 22 and the bridge server 38 provide respective entry and exit points. In between, various wireless-enabled devices, depicted as mesh radios 40-1 through 40-9, are associated with appliances 42-1 through 42-6 and structures 44-1 through 44-3 in the multi-unit environment 12. For example, a mesh radio may be associated with an appliance such as a thermostat, light switch, or door lock, for example. By way of another example, a mesh radio may be associated with a structural element in the multi-unit environment such as a wall or vent. In one operational embodiment, upstream data is received at the mesh radio and through various routing, the upstream data is forwarded through the mesh network 36, where it exits at the bridge server 38, as previously discussed.

FIG. 2C depicts one embodiment of the set top box 22. As used herein, set top box includes set top boxes or set top/back boxes. The set top box 22 includes a housing, input 50, output 52, overlay circuit 54, transmitter/receiver 56, memory 58, storage 60, and processor 62 via a bus 64. The transmitter/receiver 56 or transceiver is located within the housing in order to communicate with a proximate wireless-enabled relay device. The legacy television input 50 and the television output 52 are secured in the housing. The legacy television input 50 and the television output 52 are configured to receive downstream content from the service center 18 in a multi-unit environment and forward the downstream content to the television 24.

The processor 62 is coupled to the one or more wireless transceivers 56 and the legacy television input 50 and the television output 52. The memory 58 is accessible to the processor 62 and the memory 58 includes processor-executable instructions for execution. With respect to these instructions, in one embodiment, a search operation is specified to identify the proximate wireless-enabled relay device or mesh radio 40. The search operation utilizes the at least one or more wireless transceivers to wirelessly identify the proximate wireless-enabled device. A pairing is then established between the proximate wireless-enabled device 40 and the set top box 22. User interface instructions are then received and processed. By way of example, the user interface instructions may originate from a remote control or the television 24 in another manner. Lastly, the user interface sends the user interface instructions to the proximate wireless-enabled device 40.

FIG. 2D depicts one embodiment of the wireless-enabled relay device 40, which includes a transmitter/receiver 66, memory 68, storage 70, processor 72, and bus 74. As shown, the wireless-enabled relay device or mesh radio 40 is coupled to an appliance 42, but it may be associated with a structure as previously discussed. A housing includes the one or more wireless transceivers 66 located therein in order to communicate with another proximate wireless-enabled relay device. With respect to the instructions and the memory, a search operation is executed to specify and identify another proximate wireless-enabled device 40. Then, a pairing is established with the proximate wireless-enabled device and the user interface instructions or data is sent to the proximate wireless-enabled handheld device 40.

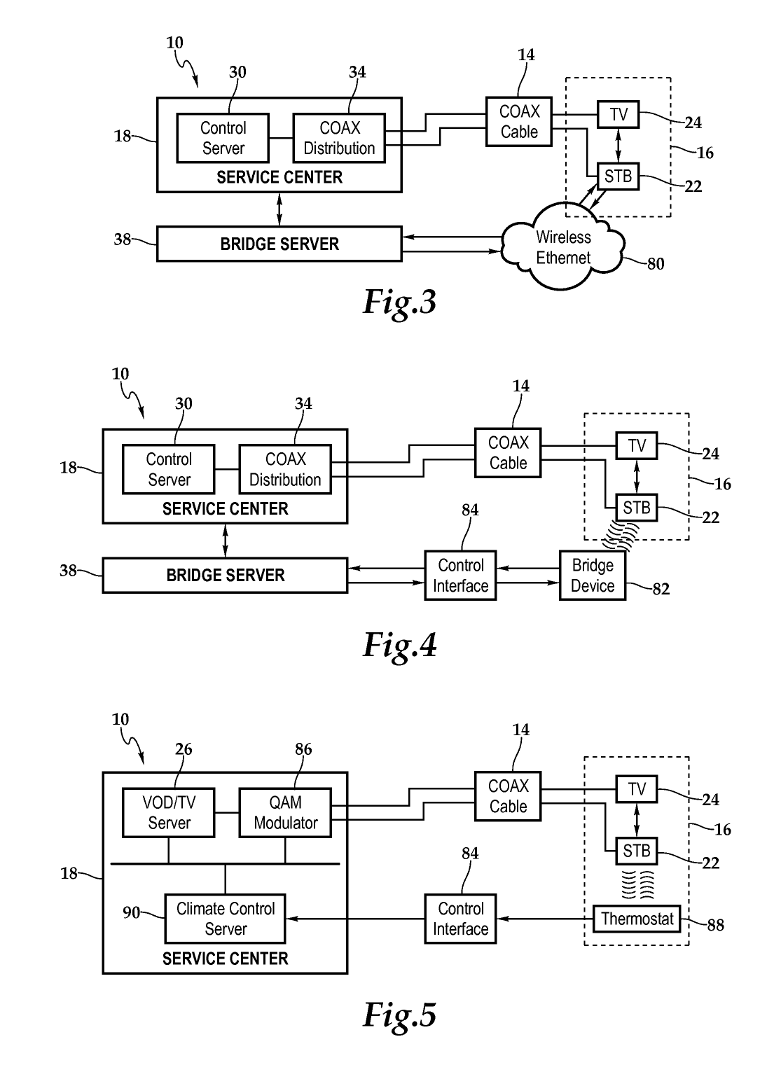

FIG. 3 is a schematic diagram depicting another embodiment of the system 10. Similar to FIG. 2A, legacy infrastructure 14 in the form of coax cable connects a service center 18 having a control server 30 and coax distribution 34 to the entertainment center 16 including the television 24 and the set top box 22 in the room. Post-construction infrastructure 20, which is a first transmission medium, in the form of a wireless ethernet 80 is interposed between the entertainment center 16 and the service server 18. The wireless ethernet 80 installed post building completion, e.g., post hotel or hospital completion, and communicating with the bridge server 38.

FIG. 4 is a schematic diagram depicting a further embodiment of the system 10. Similar to FIG. 2A and FIG. 3, legacy infrastructure 14 connects the service center 18 to the entertainment center 16. Post-construction infrastructure 20 in the form of a bridge device 82, control interface 84, and network access point 85 is interposed between the entertainment center 16 and the service server 18 to provide for upstream communication from the entertainment center 16 to the service center 18. This embodiment may include both wired and wireless infrastructure through the control interface 84. It should be appreciated that FIGS. 3 and 4 provide further architectures to the architecture presented in FIG. 2A. Moreover, it should be understood that other architectures are within the teachings presented herein. By way of summary, with respect to the previous non-limiting examples, the first bridge may be the set top box or a bridge device; each of the first, second, and third transmission mediums may be wireless or wired infrastructure, and the second bridge may be a bridge server or network access point.

With respect to the embodiment depicted in FIG. 5, coax infrastructure 14 connects the service center 18 to the entertainment center 16 in a room. The coax infrastructure 14 provides downstream communication from the service center 18 to the entertainment center 16 at a first bandwidth. An appliance, such as a thermostat 88, is interposed between the entertainment center 16 and the service server 18. The appliance or thermostat 88 may have a wireless-enabled relay device incorporated therewith and has a primary utilitarian purpose and a first transmission medium associated therewith that includes a second bandwidth. A first bridge, in the form of the set top box 22, communicatively coupled to the appliance receives upstream data on a second transmission medium away from the service center. The second transmission medium has a third bandwidth.

A second bridge, in the form of a wireless mesh unit or other device (not shown), communicatively is coupled to the appliance 88 in order to forward upstream data on a third transmission medium, having a fourth bandwidth, toward the service center 18, the third transmission medium having a fourth bandwidth. In this manner, an upstream data transmission channel is configured to send upstream data from the entertainment center 16 to the service center 18. The upstream data is unrelated to the primary purpose of the appliance. Rather, the upstream data utilizes varying bandwidths to leverage existing infrastructure to establish the alternate multi-channel bi-directional data transmission.

More particularly, continuing With reference to FIG. 5, RF-TV downstream path—QAM and 8VSB modulated digital channels, furnished by QAM modulator 86, provide a direct downstream data path from the hotel headend to the guest rooms. A thermostat control path, shown as wireless (but may also be wired) provides a communication interface from the in room thermostat 88 to the central climate server 90 located at the hotel headend. A wireless control path (e.g., Zigbee, Z-wave or Enocean) provides a wireless interface between the in-room set top box 22 to the individual control devices and the main controller. An infrared control path by way of the in-room remote control provides the interface between the guest and the set top box.

As shown, the room, which may be a hotel room, includes interfaces and wiring. The systems and methods presented herein utilize all or some of the existing interfaces to create a seamless two-way data communication paths from the hotel room to the hotel headend and back offices. The data will be traveling from interfaces to interfaces and devices to devices. Bridging communication protocols are required between interfaces and devices to provided data delivery without affecting the normal operation of each device. By way of example, one complete end to end bi-directional communication is as follows:
(1) Hotel guest submits a service request by using the infrared remote control and the set top box on screen GUI. Set top box collects data from the on screen GUI.
(2) The set top box transmits the data via a wireless interface (Such as Zigbee) to the in room thermostat.
(3) The thermostat will then transfer the data through its control interface to its central climate server at the hotel headend.
(4) The central climate server will then pass the data to the hotel PMS system via a hotel back office network.
(5) The hotel PMS system delivers the requested information to a RF-TV headend server with QAM modulator via a hotel back office network.
(6) The RF-TV headend server finally delivers the data to the guest room using a QAM channel on the RF-TV network. It can also return low bandwidth communication back up through the thermostat link.

As can be appreciated, several devices and interfaces are involved in the delivery of data. Effectively, the overall system provides a two way communication path between the hotel rooms and the hotel headend/back office. That is, this is a communication utility with multiple non-traditional data channels leveraged to provide bi-direction data delivery to enable interactive television with a limited coax infrastructure.

In one implementation, the teachings utilize the alternate control data paths existing in hotel rooms or in other residential structures to provide data communications. Bridging utilities provide the ability to use various control interfaces to provide an end to end communication path between the set top box and back office servers. Moreover, television is now an essential element for modern entertainment system in both consumer and commercial environments, yet these interactive systems are limited by the existing infrastructure of residential and commercial facilities, most of which are wired with coaxial cable for cable or satellite TV. While some coaxial cable systems can support bi-directional interaction and data communication the majority of systems do not and limit adoption of Interactive TV. The solutions to date have been to rewire or add new wires to provide the bi-directional data communication.

In one embodiment, one or more indirect data communication paths using various bridging utility solutions are employed to create an alternative bi-directional back-channel for data to reach various control systems either on property or off-site to provide the interactive data. The return path from the control systems to the television or a set top box can use the same alternative back-channel or deliver data across the coaxial cable.

The various bridging utilities can use wired or wireless infrastructures that exist in a facility that may be present to serve other devices or installed to provide this back-channel data communication. In some cases, multiple infrastructure bridges may be utilized for transferring the data packets to the interactive control system.

Some examples of the possible architecture which could be utilized include but are not limited to:
Wireless Internet protocol (802.11 standards)
Wireless mesh networking (Zigbee, Z-Wave, Enocean)
Low Bandwidth wireless networking (BlueTooth, RF antenna)
IR emitter
Wired bi-directional protocols (RS232, Serial, TTL)
Wired communication lines (Thermostat, Door Locks, HPNA, Phone Line)
Wired Power Lines (Powerline network)
WiFi
Other RF protocols

With respect to components involved, the entertainment center may be any device that an end user operates using either, IR or RF remote control, wired or wireless keyboard, mobile devices or other human interface device to navigate, manipulate and select items from a graphical user interface on a connected or embedded television, display or other visual display device. This device may interpret the data from the interface to create data packets to be sent to a connected control device or other appliance.

The appliance or connected control device is connected to the data infrastructure to an interactive device and receives the data packets across the infrastructure. This device processes the data packets and provides return path response data packets that can provide access, information, content, or authentication for the interactive device to perform or show requested functions. The connected control device may be located on the same premises as the interactive device or in a different physical location connected by various infrastructure connections.

The data bridge device serves the function of bridging data infrastructure between different wired or wireless data connection technologies, while maintaining the data packet integrity to allow multiple infrastructures to serve the function as a single data channel path. Data bridge devices may be any appliance, device or object that is capable of passing the data packet between two different transport infrastructures.

It should be understood that the systems and methods presented herein may form either a bi-directional data channel or circuit loop data channel. The primary aim of interactive television is to allow a user of a television or interactive display device to request content or services from a connected device located in another location of the system. The teachings presented herein enable the ability to leverage multiple types of infrastructure to connect the device that the user is interacting with to send requesting data packets and link to the device that provides content, access, or return data packets for the interactive experience. The systems and methods presented herein leverage one of two primary architectural designs:
1. Bi-Directional Data Channel. This is a data connection infrastructure that is capable of delivering packetized data from the Interactive Device to the Connected Control Device, and use the same cable or infrastructure for the return path data packets.
2. Circuit Loop Data Channel. This is a data connection infrastructure that is limited to providing one-way communication, yet by combining multiple devices or data bridges between the Interactive Device and Connected Control Device, and the return path to the Interactive Device is separate from the delivering infrastructure.

It should further be appreciated that the teachings presented herein may be utilized with other related applications. By way of example, visual devices with graphical user interfaces used for user interaction with control systems or content delivery systems to allow interactive services (Pay-Per-View, Video-On-Demand, Lighting Control, Menu Ordering); internal television design or external set-top-box; centrally controlled television system; centrally controlled room environmental and facility; centrally controlled door entry system; or Smart Phones/iPhones etc. and other mobile device.

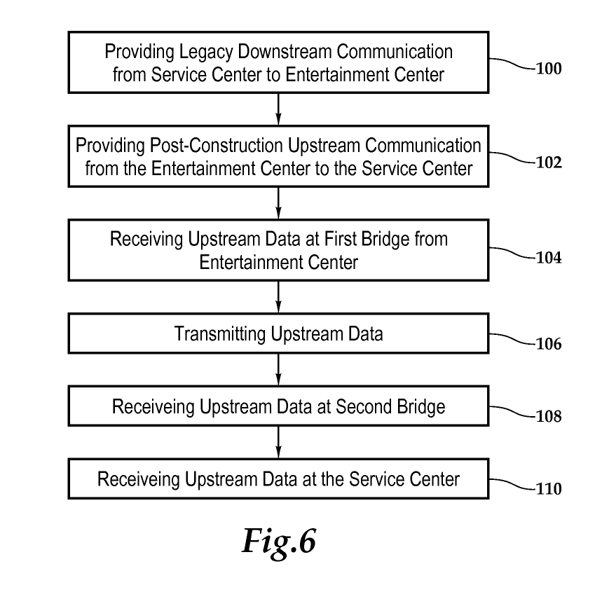

Referring to FIG. 6, one embodiment of a method for alternate multi-channel bi-directional data transmission in a multi-unit environment is presented. In the methodology, at block 100, downstream communication is provided from a service server to multiple entertainment centers at a first bandwidth via legacy infrastructure. At block 102, a post-construction infrastructure is provided in an interposing relationship between the plurality of entertainment centers and the service server.

At block 104, a first bridge is communicatively coupled to the post-construction infrastructure to receive upstream data on a second transmission medium. At block 106, upstream data is received on the second transmission medium away from the service center. As previously discussed, the second transmission medium may have a third bandwidth. At block 108, a second bridge, which is communicatively coupled to the post-construction infrastructure, is configured to forward upstream data on a third transmission medium toward the entertainment center. An upstream data transmission channel is established and completed at block 110 at the service center; the transmission includes the first, second, and third transmission mediums, wherein each of the first, second, third, and fourth bandwidths is different.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for alternate multi-channel bi-directional data transmission in a multi-unit environment, the system comprising:
legacy infrastructure connecting a plurality of entertainment centers in respective rooms to a service server in the multi-unit environment, the legacy infrastructure configured to provide downstream communication from the service server to the plurality of entertainment centers at a first bandwidth;
a post-construction infrastructure interposed between the plurality of entertainment centers and the service server, the post-construction infrastructure embedded in the multi-unit environment following construction of the multi-unit environment, the post-construction infrastructure having a first transmission medium with a second bandwidth;
each of the plurality of entertainment centers having a first bridge communicatively coupled to the post-construction infrastructure, the first bridge configured to receive upstream data on a second transmission medium away from the plurality of entertainment centers and toward the service center, the second transmission medium having a third bandwidth;
a second bridge communicatively coupled to the post-construction infrastructure, the second bridge configured to forward upstream data on a third transmission medium toward the service center, the third transmission medium having a fourth bandwidth; and
an upstream data transmission channel configured to send upstream data from the plurality of entertainment centers to the service center, the upstream data transmission channel including the first, second, and third transmission mediums;
the legacy infrastructure and upstream data transmission channel combining to define an interactive entertainment center experience,
wherein each of the first, second, third, and fourth bandwidths is different.

2. The system as recited in claim 1, wherein the multi-unit environment further comprises a structure selected from the group consisting of multi-family residences, dormitories, hotels, and hospitals.

3. The system as recited in claim 1, wherein the legacy infrastructure further comprises coax cable.

4. The system as recited in claim 1, wherein each of the plurality of entertainment centers further comprises a television and a set top box.

5. The system as recited in claim 1, wherein the service center further comprises a video-on-demand system.

6. The system as recited in claim 1, wherein the downstream communication further comprises content selected from the group consisting of television content, video on demand, and menu content.

7. The system as recited in claim 1, wherein the post-construction infrastructure further comprises a wireless network.

8. The system as recited in claim 1, wherein the post-construction infrastructure embedded in the multi-unit environment further comprises a retrofit design installed in the multi-unit environment.

9. The system as recited in claim 1, wherein the first bridge further comprises the set top box.

10. The system as recited in claim 1, wherein the first bridge further comprises a wireless-to-wired bridge device.

11. The system as recited in claim 1, wherein the upstream data communication channel further comprises a configuration to send user interface data relative to content selected from the group consisting of television content, video on demand, and menu content.

12. The system as recited in claim 1, wherein the second bridge further comprises a wireless relay.

13. The system as recited in claim 1, wherein the second bridge further comprises a bridge sever.

14. A system for alternate multi-channel bi-directional data transmission in a multi-unit environment, the system comprising:
coax infrastructure connecting a plurality of entertainment centers in respective rooms to a service server in the multi-unit environment, the coax infrastructure providing downstream communication from the service server to the entertainment center at a first bandwidth;
a plurality of appliances interposed between the plurality of entertainment centers and the service server, the plurality of appliances having a primary utilitarian purpose and a first transmission medium associated therewith, the first transmission medium having a second bandwidth;
for each of the plurality of entertainment centers, a first bridge communicatively coupled to the appliance for receiving upstream data on a second transmission medium away from the entertainment center and toward the service center, the second transmission medium having a third bandwidth;
a second bridge communicatively coupled to the appliance for forwarding upstream data on a third transmission medium toward the service center, the third transmission medium having a fourth bandwidth;
an upstream data transmission channel configured to send upstream data from the plurality of entertainment servers to the service center, the upstream data being unrelated to the primary purpose of the appliance, the upstream data transmission channel including the first, second, and third transmission mediums;
the coax infrastructure and upstream data transmission channel combining to define an interactive entertainment center experience,
wherein each of the first, second, third, and fourth bandwidths is different.

15. The system as recited in claim 14, wherein the appliance further comprises a device selected from the group consisting of thermostats, light switches, and door lock mechanisms.

16. A method for alternate multi-channel bi-directional data transmission in a multi-unit environment, the method comprising:
providing downstream communication from a service server to a plurality of entertainment centers at a first bandwidth via legacy infrastructure, the legacy infrastructure connecting the plurality of entertainment centers in respective rooms to the service server in the multi-unit environment;
providing a post-construction infrastructure in an interposing relationship between the plurality of entertainment centers and the service server, the post-construction infrastructure embedded in the multi-unit environment following construction of the multi-unit environment, the post-construction infrastructure having a first transmission medium with a second bandwidth;
providing a first bridge communicatively coupled to the post-construction infrastructure, the first bridge configured to receive upstream data on a second transmission medium;
receiving upstream data on the second transmission medium away from the service center, the second transmission medium having a third bandwidth;
providing a second bridge communicatively coupled to the post-construction infrastructure, the second bridge configured to forward upstream data on a third transmission medium toward the entertainment center;
forwarding upstream data on the third transmission medium toward the entertainment center, the third transmission medium having a fourth bandwidth;
establishing an upstream data transmission channel to send upstream data from the service server to the entertainment server, the upstream data transmission channel including the first, second, and third transmission mediums;
providing an interactive entertainment center experience by combining the legacy infrastructure and upstream data transmission channel,
wherein each of the first, second, third, and fourth bandwidths is different.

17. The method as recited in claim 16, further comprising selecting the multi-unit environment from the group consisting of multi-family residences, dormitories, hotels, and hospitals.

18. A system for alternate multi-channel bi-directional data transmission in a multi-unit environment, the system comprising:
a plurality of set top boxes located in a respective plurality of rooms in the multi-unit environment, each of the plurality of set top boxes comprising:
a housing;
one or more wireless transceivers located within the housing, the one or more wireless transceivers configured to communicate with a proximate wireless-enabled relay device;
a legacy television input and a television output secured in the housing, the legacy television input and the television output configured to receive downstream content from a service center in a multi-unit environment and forward the downstream content to a television;
a processor coupled to the one or more wireless transceivers and the legacy television input and the television output; and
a memory accessible to the processor, the memory including processor-executable instructions that, when executed, cause the processor to:
specify a search operation to identify the proximate wireless-enabled device, wherein the search operation utilizes the at least one or more wireless transceivers to wirelessly identify the proximate wireless-enabled device;
establish a pairing between the proximate wireless-enabled device and the set top box;
receive and process user interface instructions; and
send the user interface instructions to the proximate wireless-enabled device; and
a plurality of wireless-enabled relay devices including the wireless-enabled relay device, each of the plurality of wireless-enabled relay devices comprising:
a housing;
one or more wireless transceivers located within the housing, the one or more wireless transceivers operable to communicate with another proximate wireless-enabled device;
a processor coupled to the one or more wireless transceivers; and
a memory accessible to the processor, the memory including processor-executable instructions that, when executed, cause the processor to:
specify a search operation to identify another proximate wireless-enabled device, wherein the search operation utilizes the at least one or more wireless transceivers to wirelessly identify the proximate wireless-enabled device;
establish a pairing with the proximate wireless-enabled device; and
send the user interface instructions to the proximate wireless-enabled device; and
wherein at least one of the plurality of wireless-enabled devices is disposed in communication with the service center such that bi-directional communication is established downstream from the service center to the plurality of set top boxes via legacy infrastructure and upstream from the plurality of set top boxes to the service center via the wireless-enabled relay devices.

19. The system as recited in claim 18, wherein the multi-unit environment further comprises a structure selected from the group consisting of multi-family residences, dormitories, hotels, and hospitals.

20. The system as recited in claim 18, wherein the legacy infrastructure further comprises coax cable.
